(19) United States
(12) Patent Application Publication
(10) Pub. No.: US 2016/0253970 A1
(43) Pub. Date: Sep. 1, 2016

(54) CURVED DISPLAY PANEL AND CURVED DISPLAY DEVICE

(71) Applicant: SHENZHEN CHINA STAR OPTOELECTRONICS TECHNOLOGY CO., LTD., Shenzhen, Guangdong (CN)

(72) Inventors: Cheng-Hung Chen, Shenzhen, Guangdong (CN); Shih-Hsun Lo, Shenzhen, Guangdong (CN); Chuan Wu, Shenzhen, Guangdong (CN)

(21) Appl. No.: 14/389,643

(22) PCT Filed: Jul. 2, 2014
(86) PCT No.: PCT/CN2014/081516

§ 371 Date: Sep. 30, 2014

(30) Foreign Application Priority Data
Jun. 27, 2014 (CN) 201410300639.1

(51) Int. Cl. G09G 3/36

(52) U.S. Cl. CPC G09G 3/3607; G09G 3/3677; G09G 3/3688; G09G 2300/0452; G09G 2320/0242; G09G 2300/04; G09G 2360/06

(57) ABSTRACT

A curved display panel and a curved display device are disclosed. Long sides of each sub-pixels are parallel to long sides of the curved display panel, short sides of each sub-pixels are parallel to short sides of the curved display panel. The curved display panel with such a configuration can greatly reduce the area of the black clots on both sides of the curved display panel, and reduce the color cast on the left and right regions of the curved display panel, which reduces the uneven picture problem of the curved display panel.

### Field of the Invention

The present invention relates to the technical field of display panels, and in particular, relates to a curved display panel and a curved display device.

### BACKGROUND OF THE INVENTION

Generally, in the field of curved thin film transistor liquid crystal display (TFT-LCD), gate lines 101 are parallel to a long side 100a of the curved display device (i.e. parallel to the curved line), while data lines 102 are perpendicular to the long side 100a of the curved display panel, and a long side 11a of each pixel 11 is perpendicular to the long side 100a of the curved display panel (i.e. all of the pixels 11 are vertically arranged). Refer to FIG. 1a, which takes the pixel 11 for example, to describe and illustrate the pixel structure of a conventional curved TFT-LCD, where the numeral 100b indicates a short side of the curved display panel, the numeral 11b indicates a short side of the pixel.

When fabricating the display device, since an upper substrate (color filter substrate, CF) 12 and a lower substrate 13 (TFT substrate) will sag in the center of the display panel, and will gradually generate relative shift while horizontally moving to the left and right sides, hence there is a greater relative shift in the upper and the lower substrates on the left and right sides of the display panel. Referring to FIGS. 1b and 1c, which are both structure diagrams of conventional curved display devices; furthermore, since the greater relative shift of the upper and the lower substrates causes more light to be shielded by a black matrix, the aperture ratio is therefore decreased, hence the brightness on left and right regions is reduced. As shown in FIG. 1c, black clots appear in the left and right regions of the display panel.

Because the upper substrate relative to the lower substrate is not moved to the left or the right side at the same time, and instead is anchored in the center and externally expanded to both the left and the right sides; that is, the upper substrate and the lower substrate are externally expanded to an opposite direction. When in a greater relative shift, a variation of the leaked color causes the black clots appearing on the left and the right sides having a bigger color cast.

Therefore, it is necessary to provide a new technical solution to solve the above problem.

### SUMMARY OF THE INVENTION

The objective of the present invention is to provide a curved display panel and a curved display device which are able to reduce the generation of obvious black clots and color casts on left and right regions of the display panel, so as to reduce uneven pictures on the display device, and enhance the aperture ratio.

To solve the above problem, a technical feature of the present invention is:

A curved display panel, comprising a pixel structure, scan lines, and data lines disposed therein; four edge frames of the curved display panel are constructed by two first edge frames and two second edge frames, the first edge frames and the second edge frames are adjacent to each other, the first edge frames are curved edge frames, a length of the first edge frames is greater than that of the second edge frames; wherein the scan lines are disposed perpendicular to the first edge frames, and are disposed parallel to the second edge frames; the data lines are disposed perpendicular to the second edge frames, and are disposed parallel to the first edge frames.

The pixel structure comprises two or more pixel units; each of the pixel units comprises three sub-pixels of a red sub-pixel, a green sub-pixel, and a blue sub-pixel; each of the sub-pixels are arranged in rectangular shape, each of the sub-pixels comprises long sides and short sides, where the long sides of each sub-pixel are disposed parallel to the first edge frames, the short sides of each sub-pixel are disposed parallel to the second edge frames, and the long sides of each sub-pixel are perpendicular to the second edge frames, the short sides of each sub-pixel are perpendicular to the first edge frames.

The curved display panel described above further comprises a first driving circuit for driving the scan lines to provide switching control signals to the pixel structure.

The curved display panel described above further comprises a second driving circuit for driving the data lines to provide data signals to the pixel structure.

A curved display panel comprises a pixel structure disposed therein, four edge frames of the curved display panel are constructed by two first edge frames and two second edge frames, the first edge frames and the second edge frames are adjacent to each other, the first edge frames are curved edge frames, a length of the first edge frames is greater than that of the second edge frames.

The pixel structure comprises two or more pixel units; each of the pixel units comprises three sub-pixels of a red sub-pixel, a green sub-pixel, and a blue sub-pixel; each of the sub-pixels are arranged in rectangular shape, each of the sub-pixels comprises long sides and short sides, where the long sides of each sub-pixel are disposed parallel to the first edge frames, the short sides of each sub-pixel are disposed parallel to the second edge frames, and the long sides of each sub-pixel are perpendicular to the second edge frames, the short sides of each sub-pixel are perpendicular to the first edge frames.

The curved display panel described above comprises scan lines, the data lines are disposed perpendicular to the first edge frames, and are disposed parallel to the second edge frames.

The curved display panel described above comprises data lines, the data lines are disposed perpendicular to the second edge frames, and are disposed parallel to the first edge frames.

The curved display panel described above further comprises a first driving circuit for driving the scan lines to provide switching control signals to the pixel structure.

The curved display panel described above further comprises a second driving circuit for driving the data lines to provide data signals to the pixel structure.

A curved display device comprises a curved display panel and a pixel structure disposed therein, four edge frames of the curved display panel are constructed by two first edge frames and two second edge frames, the first edge frames are adjacent to the second edge frames, the first frames are curved edge frames, a length of the first edge frames is greater than that of the second edge frames.

The pixel structures comprises two or more pixel units; each of the pixel units comprises three sub-pixels of a red sub-pixel, a green sub-pixel, and a blue sub-pixel; each of the sub-pixels are arranged in rectangular shape, each of the sub-pixels comprises long sides and short sides, where the long sides of each sub-pixel are disposed parallel to the first edge frames, the short sides of each sub-pixel are disposed parallel to the second edge frames, and the long sides of each sub-pixel are perpendicular to the second edge frames, the short sides of each sub-pixel are perpendicular to the first edge frames.

The curved display panel of the curved display device described above comprises scan lines, the scan lines are disposed perpendicular to the first edge frames, and are disposed parallel to the second edge frames.

The curved display panel of the curved display device described above comprises data lines, the data lines are disposed perpendicular to the second edge frames, and are disposed parallel to the first edge frames.

The curved display panel of the curved display device described above further comprises a first driving circuit for driving the scan lines to provide switching control signals to the pixel structure.

The curved display panel of the curved display device described above further comprises a second driving circuit for driving the data lines to provide data signals to the pixel structure.

Compared to the conventional art, in the display panel of the present invention, the long sides of each sub-pixel are disposed parallel to the long edge frames of the curved display panel, the short sides of each sub-pixel are disposed parallel to the short edge frames of the curved display panel, a curved display panel with such a configuration can greatly reduce the area of the black clots on both sides, and reduce the color cast on the left and right regions of the curved display panel, which reduces the uneven picture problem of the curved display panel.

### BRIEF DESCRIPTION OF THE DRAWINGS

FIGS. 1a-1c are schematic diagrams of conventional curved TFT-LCD structures;

FIG. 2 is a schematic diagram of a curved display panel provided by the present invention;

FIG. 3 is a schematic diagram of another curved display panel provided by the present invention;

FIG. 4 is a schematic diagram of a pixel structure in the curved display panel provided by the present invention;

FIG. 5 is a schematic diagram of a curved display device provided by the present invention.

### DETAILED DESCRIPTION OF THE PREFERRED EMBODIMENTS

Please refer to the drawings, in which the same component symbol represents the same component, the principles of the present invention are implemented in a suitable embodiment. The following description is based on illustrated specific embodiments of the present invention, which should not be construed as limitations for other specific embodiments that are not discussed in in the present invention.

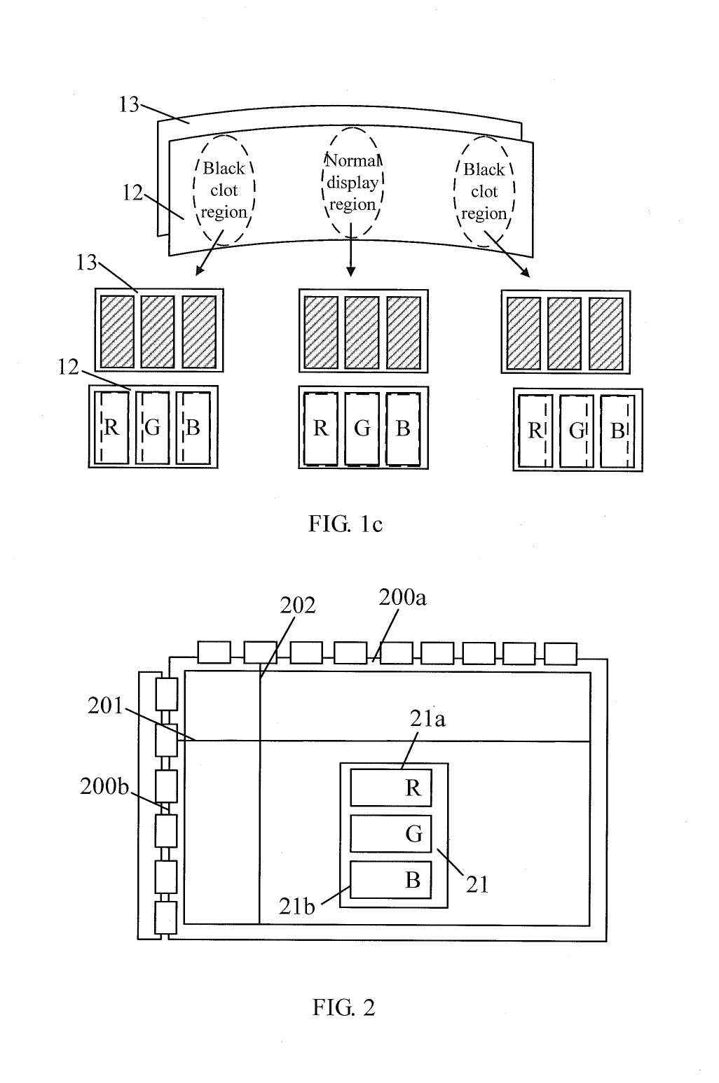

Please refer to FIG. 2, which is a schematic diagram of a curved display panel 200 according to a preferred embodiment of the present invention. The curved display panel 200 comprises a pixel structure disposed therein, four edge frames of the curved display panel 200 are constructed by two first edge frames 200a and two second edge frames 200b. The first edge frames 200a are adjacent to the second edge frames 200b, and the first edge frames 200a are curved edge frames. A length of the first edge frames 200a is greater than that of the second edge frames 200b.

The pixel structure comprises two or more pixel units 21. Each of the pixel units 21 comprises three sub-pixels of a red sub-pixel “R”, a green sub-pixel “G”, and a blue sub-pixel “B”. The sub-pixels are arranged in a rectangular shape. Each of the sub-pixels comprises long sides 21a and short sides 21b, where the long sides 21a of each sub-pixel are disposed parallel to the first edge frames 200a, the short sides 21b of each sub-pixel are disposed parallel to the second edge frames 200b, the long sides 21a of each sub-pixel are perpendicular to the second edge frames 200b, and the short sides 21b of each sub-pixel are perpendicular to the first edge frames 200a.

It should be understood that FIG. 2 illustrates a pixel unit 21 to describe the pixel structure of the curved display panel, which does not limit the present invention.

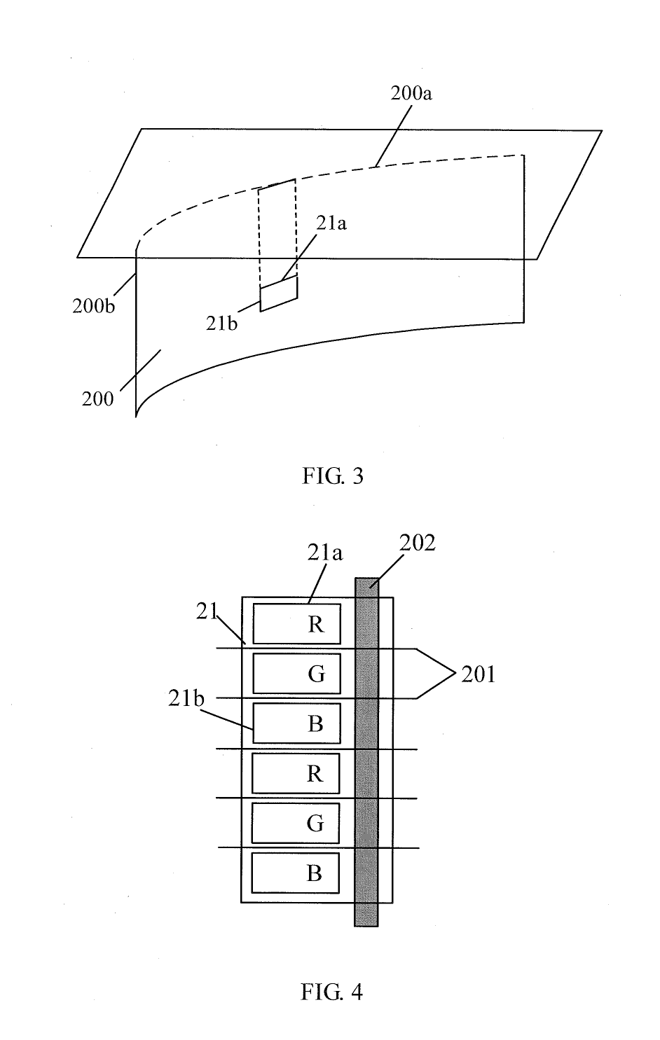

Together with FIG. 3, which is a schematic diagram of another curved display panel 200 according to another preferred embodiment of the present invention, where the first edge frame 200a is a curved edge frame, i.e., the long side of the curved display panel 200, the second edge frame 200b, is the short side of the curved display panel, and the second edge frame 200b is perpendicular to a surface A where the first edge frame 200a is located.

Furthermore, as shown in FIG. 3, the sub-pixel is disposed in the curved display panel 200, the long side 21a of the sub-pixel is perpendicular to the second edge frame 200b, and the long side 21 a of the sub-pixel is parallel to the surface A; the short side of the sub-pixel is parallel to the second edge frame 200b, and the short side 21b of the sub-pixel is perpendicular to the surface A where the first edge frame 200a is located. It should be understood that with the combination of FIGS. 2 and 3, as seen from the above analysis, the first edge frame 200a is a curved edge frame, and a length of the long side 21a of the sub-pixel is much less than that of the curved edge frame. Therefore, in the embodiments of the present invention, the long side 21 a of the sub-pixel can be regarded as disposed parallel to the curved edge frame (i.e., the first edge frame 200a), and the short side 21b of the sub-pixels 200a can be regarded as disposed perpendicular to the first edge frame 200a.

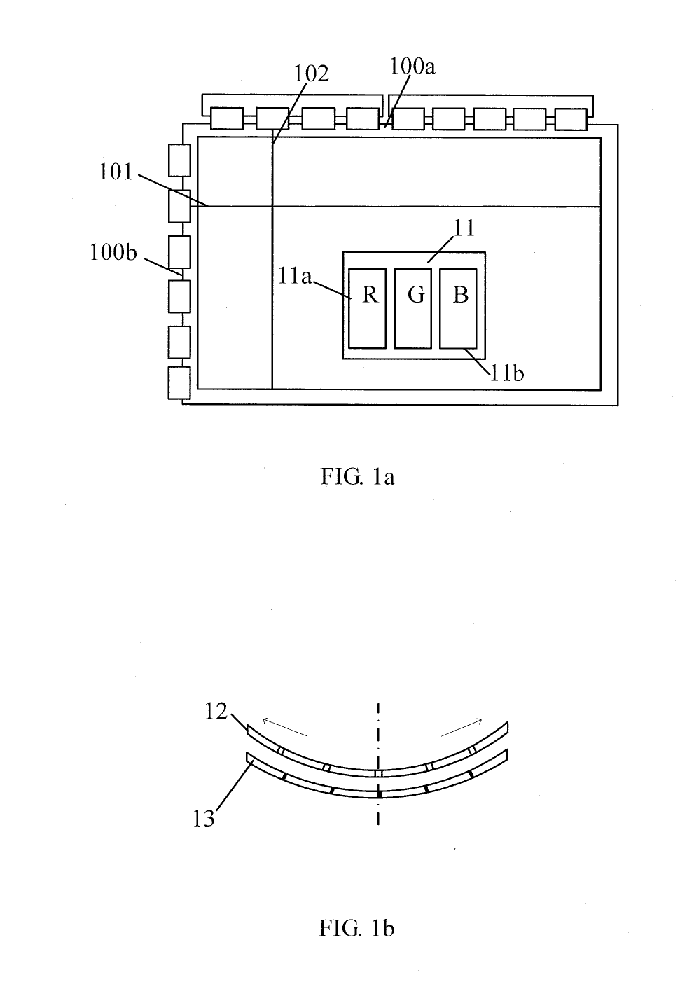

From the above, compared to the curved display panel as shown in FIG. 1, each of the sub-pixels is laterally arranged in the embodiments of the present invention, which means that the long side 21a of each sub-pixel is disposed parallel to the first edge frame 200a, the short side 21b of each sub-pixel is parallel to the second edge frame 200b, as shown in FIGS. 2 and 3. A curved display panel with such a configuration can greatly reduce the area of the black clots on both sides, and reduce the color cast on the left and right regions of the curved display panel, which reduces the uneven picture problem of the curved display panel.

Preferably, please refer to FIG. 2, the curved display panel 200 comprises scan lines 202 perpendicular to the first edge frames 200a and parallel to the second edge frames 200b. The curved display panel 200 comprises data lines 201 perpendicular to the second edge frames 200b and parallel to the first edge frames 200a.

That is, the scan lines 202 are disposed parallel to the short side 21b of the sub-pixel, and the data lines 201 are disposed parallel to the long side 21a of the sub-pixel. Also refer to FIG. 4, which is a schematic diagram of a connection between the pixel units and the data lines 201 and the scan lines 202. As shown in FIG. 4, the illustration of the connection between two pixel units, the data lines 201, and the scan lines 202 should not be construed as a limitation to the present invention.

The curved display panel 200 further comprises a first driving circuit for driving the scan lines 202 to provide switching control signals to the pixel structure, and can further comprise a second driving circuit for driving the data lines 201 to provide data signals to the pixel structure. It should be understood that the configurations of the first driving circuit and the second driving circuit of the embodiment is not considered as a specific limitation.

Hereinafter, an analysis was made between an aperture region of a conventional display panel structure (FIG. 1a) and an aperture region of the curved display panel 200 according to the embodiments provided by the present invention (FIG. 2):

FIG. 1 a illustrates a curved display panel structure, gate lines 101 are parallel to the long side 100a of the curved display device (i.e., parallel to the curved edge frame), while data lines 102 are perpendicular to the long side 100a of the curved display panel, and the long side 11a of each sub-pixel is perpendicular to the long side 100a of the curved display panel, where a length of the long side 11a of the sub-pixel is (m), a length of the short side 11b is (n).

According to the glass stress analysis, referring to FIGS. 1b and 1c, a relative shift is gradually expanded from the center of the display panel to the left and right sides in a direction of the long side 100a, and the shift direction of the left and right sides is opposite. Depending on the direction and magnitude of the relative shift, if the shift of a sub-pixel is (s) um, then a shading area caused by a sub-pixel (aperture region loss) will be (m×s) um².

FIG. 2 illustrates a curved display panel structure, the long side 21a of each sub-pixel is disposed parallel to the first edge frames 200a, the short side 21b of each sub-pixel is disposed parallel to the second edge frames 200b, and the long side 21a of each sub-pixel is perpendicular to the second edge frame 200b. The short side of each sub-pixel is perpendicular to the first edge frame 200a. The scan lines 202 are disposed perpendicular to the first edge frame 200b, and are disposed parallel to the first edge frame 200a.

It should be understood that, under the same amount of shift, the lost aperture region at fixed point is (m×s) um². However, the value of m is far greater than that of n. Therefore, by adopting the curved display panel structure of the present invention, the aperture region loss is much smaller than that of the design in the conventional curved display panel, such that the present invention can maximize the reduction of negative display caused by huge aperture ratio loss, which means that it can greatly reduce the area of the black clots on both sides as well, and reduce the color cast on the left and right regions of the curved display panel, thereby reducing the uneven picture problem of the curved display panel.

For a better implementation of the curved display panel provided in the embodiments of the present invention, the present invention further provides a curved display device comprising the curved display panel. Herein, the function of the term is the same as the curved display panel described above, the specific implementation details can refer to the description of the curved display panel in the embodiments.

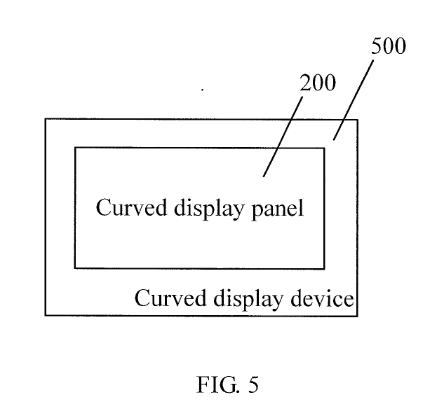

Please refer to FIG. 5, which is a schematic diagram of a curved display device provided by the present invention. The curved display device 500 comprises the curved display panel 200 as shown in FIG. 2.

The curved display panel 200 comprises a pixel structure disposed therein, four edge frames of the curved display panel 200 are constructed by two first edge frames 200a and two second edge frames 200b. The first edge frames 200a are adjacent to the second edge frames 200b, the first edge frames 200a are curved edge frames. A length of the first edge frames 200a is greater than that of the second edge frames 200b.

The pixel structure comprises two or more pixel units 21; each of the pixel units 21 comprises three sub-pixels of a red sub-pixel “R”, a green sub-pixel “G”, and a blue sub-pixel “B”; each of the sub-pixels are arranged in a rectangular shape, each of the sub-pixels comprises long sides 21a and short sides 21b, where the long side 21a of each sub-pixel are disposed parallel to the first edge frames 200a, the short side 21b of each sub-pixel are disposed parallel to the second edge frames 200b, and the long sides 21a of each sub-pixel are perpendicular to the second edge frames 200b, the short sides 21b of each sub-pixel are perpendicular to the first edge frames 200a.

It should be understood that FIG. 2 illustrates a pixel unit 21 to describe the pixel structure of the curved display panel, which does not limit the present invention.

Together with FIG. 3, which is a schematic diagram of another curved display panel 200 provided by the present invention, where the first edge frame 200a is a curved edge frame, i.e., the long side of the curved display panel 200, the second edge frame 200b, is the short side of the curved display panel, and the second edge frame 200b is perpendicular to a surface A where the first edge frame 200a is located.

Furthermore, as shown in FIG. 3, the sub-pixel is disposed in the curved display panel 200, the long side 21a of the sub-pixel is perpendicular to the second edge frame 200b, and the long side 21a of the sub-pixel is parallel to the surface A; the short side of the sub-pixel is parallel to the second edge frame 200b, and the short side 21b of the sub-pixel is perpendicular to the surface A where the first edge frame 200a is located. It should be understood that with the combination of FIGS. 2 and 3, as seen from the above analysis, the first edge frame 200a is a curved edge frame, and a length of the long side 21a of the sub-pixel is much less than that of the curved edge frame. Therefore, in the embodiments of the present invention, the long side 21a of the sub-pixel can be regarded as being disposed parallel to the curved edge frame (i.e., the first edge frame 200a), and the short side 21b of the sub-pixels 200a can be regarded as being disposed perpendicular to the first edge frame 200a.

From the above, compared to the curved display panel as shown in FIG. 1, each of the sub-pixels is laterally arranged in the embodiments of the present invention, which means that the long side 21a of each sub-pixel is disposed parallel to the first edge frame 200a, the short side 21b of each sub-pixel is parallel to the second edge frame 200b, as shown in FIGS. 2 and 3. The curved display panel with such configuration can greatly reduce the area of the black clot on both sides, and reduce the color cast on the left and right regions of the curved display panel, which reduces the uneven picture problem of the curved display panel.

Preferably, please refer to FIG. 2, the curved display panel 200 comprises scan lines 202, the scan lines 202 are disposed perpendicular to the first edge frames 200a, and are disposed parallel to the second edge frames 200b. The curved display panel 200 comprises data lines 201, the data lines 201 are disposed perpendicular to the second edge frames 200b, and are disposed parallel to the first edge frames 200a.

That is, the scan lines 202 are disposed parallel to the short side 21b of the sub-pixel, the data lines 201 are disposed parallel to the long side 21a of the sub-pixel. Also refer to FIG. 4, which is a schematic diagram of a connection between the pixel units and the data lines 201 and the scan lines 202. As shown in FIG. 4, the illustration of the connection between two pixel units, the data lines 201, and the scan lines 202 should not be construed as a limitation to the present invention.

The curved display panel 200 further comprises a first driving circuit for driving the scan lines 202 to provide switching control signals to the pixel structure, and can further comprise a second driving circuit for driving the data lines 201 to provide data signals to the pixel structure. It should be understood that the configurations of the first driving circuit and the second driving circuit of the embodiment are not considered as a specific limitation.

Hereinafter, an analysis was made between an aperture region of a conventional display panel structure (FIG. 1a) and an aperture region of the curved display panel 200 according to the embodiments provided by the present invention (FIG. 2):

FIG. 1a illustrates a curved display panel structure. According to the glass stress analysis, a relative shift is gradually expanded from the center of the display panel to the left and right sides in a direction of the long side 100a, and the shift direction of the left and right sides is opposite, refer to FIGS. 1b and 1c. Depending on the direction and magnitude of the relative shift, if the shift of a sub-pixel is (s) urn, then a shading area caused by a sub-pixel (aperture region loss) will be (m×s) um².

FIG. 2 illustrates a curved display panel structure, under the same amount of shift, the lost aperture region at fixed point is (m×s) um². However, the value of m is far greater than that of n. Therefore, by adopting the curved display panel structure of the present invention, the aperture region loss is much smaller than that of the design in the conventional curved display panel, thus the present invention can maximize the reduction of negative display caused by the huge aperture ratio loss.

As can be seen from the above, the curved display device 500 provided by the present embodiment comprises a curved display panel 200 described above, each of the sub-pixels is laterally arranged, i.e. the long side 21 a of each sub-frame is disposed parallel to the first edge frame 200a, the short side of each sub-pixel 21b is disposed parallel to the second edge frame 200b, as shown in FIGS. 2 and 3. A curved display panel with such configuration can greatly reduce the area of the black clots on both sides, and reduce the color cast on the left and right regions of the curved display panel, which reduces the uneven picture problem of the curved display panel.

In the above embodiments, the description of various embodiments have different emphases; parts without a detailed description in a certain embodiment can refer to the detailed description above, and will not be repeated herein.

A person skilled in the art will recognize that the word “preferred” used herein means serving as an example, instance, or illustration. Any aspect or design described herein as “preferred” is not necessarily to be construed as advantageous over other aspects or designs. Rather, use of the word “preferred” is intended to present concepts in a concrete fashion. As used in this application, the term “or” is intended to mean an inclusive “or” rather than an exclusive “or”. That is, unless specified otherwise, or clear from context, “X employs 101 or 102” is intended to mean any of the natural inclusive permutations. That is, if X employs 101; X employs 102; or X employs both 101 and 102, then “X employs 101 or 102” is satisfied under any of the foregoing instances.

Moreover, despite one or more implementations relative to the present disclosure being illustrated and described, equivalent alterations and modifications will occur to others skilled in the art upon reading and understanding this specification and the annexed drawings. The present disclosure comprises such modifications and variations, and is to be limited only by the terms of the appended claims. In particular, regarding the various functions performed by the above described components, the terms used to describe such components (i.e. elements, resources, etc.) are intended to correspond (unless otherwise indicated) to any component, which performs the specified function of the described component (i.e., that is functionally equivalent), even though not structurally equivalent to the disclosed structure which performs the function in the illustrated implementations of the disclosure. In addition, although a particular feature of the disclosure may have been disclosed with respect to only one of several implementations, such a feature may be combined with one or more other features of the other implementations as may be desired and advantageous for any given or particular application. Also, to the extent that the terms “including”, “includes”, “having”, “has”, “with”, or variants thereof are used in the detailed description or in the claims, such teens are intended to be inclusive in a manner similar to the term “comprising”.

The embodiments were chosen and described in order to explain the principles of the disclosure and their practical application so as to activate others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims, rather than the foregoing description and the exemplary embodiments described therein.

What is claimed is:

1. A curved display panel, comprising a pixel structure, scan lines, and data lines disposed therein;
four edge frames of the curved display panel are constructed by two first edge frames and two second edge frames, the first edge frames and the second edge frames are adjacent to each other, the first edge frames are curved edge frames, a length of the first edge frames is greater than that of the second edge frames;
wherein the scan lines are disposed perpendicular to the first edge frames, and are disposed parallel to the second edge frames;
the data lines are disposed perpendicular to the second edge frames, and are disposed parallel to the first edge frames;
the pixel structure comprises:
two or more pixel units;
each of the pixel units comprises three sub-pixels of a red sub-pixel, a green sub-pixel, and a blue sub-pixel;
each of the sub-pixels is arranged in a rectangular shape, each of the sub-pixels comprises long sides and short sides, the long sides of each sub-pixel are disposed parallel to the first edge frames, the short sides of each sub-pixel are disposed parallel to the second edge frames, and the long sides of each sub-pixel are perpendicular to the second edge frames, the short sides of each sub-pixel are perpendicular to the first edge frames.

2. The curved display panel as claimed in claim 1, wherein the curved display panel further comprises a first driving circuit for driving the scan lines to provide switching control signals to the pixel structure.

3. The curved display panel as claimed in claim 1, wherein the curved display panel further comprises a second driving circuit for driving the data lines to provide data signals to the pixel structure.

4. A curved display panel, comprising a pixel structure disposed therein, four edge frames of the curved display panel being constructed by two first edge frames and two second edge frames, the first edge frames and the second edge frames being adjacent to each other, the first edge frames being curved edge frames, a length of the first edge frames being greater than that of the second edge frames, wherein the pixel structure comprises:
two or more pixel units;
each of the pixel units comprises three sub-pixels of a red sub-pixel, a green sub-pixel, and a blue sub-pixel;
each of the sub-pixels is arranged in a rectangular shape, each of the sub-pixels comprises long sides and short sides, where the long sides of each sub-pixel are disposed parallel to the first edge frames, the short sides of each sub-pixel are disposed parallel to the second edge frames, and the long sides of each sub-pixel are perpendicular to the second edge frames, the short sides of each sub-pixel are perpendicular to the first edge frames.

5. The curved display panel as claimed in claim 4, wherein the curved display panel comprises scan lines, the data lines are disposed perpendicular to the first edge frames, and are disposed parallel to the second edge frames.

6. The curved display panel as claimed in claim 4, wherein the curved display panel comprises data lines, the data lines are disposed perpendicular to the second edge frames, and are disposed parallel to the first edge frames.

7. The curved display panel as claimed in claim 5, wherein the curved display panel further comprises a first driving circuit for driving the scan lines to provide switching control signals to the pixel structure.

8. The curved display panel as claimed in claim 6, wherein the curved display panel further comprises a second driving circuit for driving the data lines to provide data signals to the pixel structure.

9. A curved display device, comprising a curved display panel and a pixel structure disposed therein, four edge frames of the curved display panel being constructed by two first edge frames and two second edge frames, the first edge frames being adjacent to the second edge frames, the first frames being curved edge frames, a length of the first edge frames being greater than that of the second edge frames, wherein the pixel structure comprises:
two or more pixel units;
each of the pixel units comprises three sub-pixels of a red sub-pixel, a green sub-pixel, and a blue sub-pixel;
each of the sub-pixels is arranged in a rectangular shape, each of the sub-pixels comprises long sides and short sides, where the long sides of each sub-pixel are disposed parallel to the first edge frames, the short sides of each sub-pixel are disposed parallel to the second edge frames, and the long sides of each sub-pixel are perpendicular to the second edge frames, the short sides of each sub-pixel are perpendicular to the first edge frames.

10. The curved display panel as claimed in claim 9 further comprising scan lines disposed perpendicular to the first edge frames and disposed parallel to the second edge frames.

11. The curved display panel as claimed in claim 9 further comprising data lines disposed perpendicular to the second edge frames and disposed parallel to the first edge frames.

12. The curved display panel as claimed in claim 10 further comprising a first driving circuit for driving the scan lines to provide switching control signals to the pixel structure.

13. The curved display panel as claimed in claim 11 further comprising a second driving circuit for driving the data lines to provide data signals to the pixel structure.
